(19) United States
(12) Patent Application Publication
(10) Pub. No.: US 2016/0101443 A1
(43) Pub. Date: Apr. 14, 2016

(54) Separator and Dryer for Ammunition Casings and Cleaning Media

(71) Applicants: Gordon Andrew Christensen, Gretna, NE (US); Steven Matthew Christensen, Gretna, NE (US); David Michael Christensen, Gretna, NE (US)

(72) Inventors: Gordon Andrew Christensen, Gretna, NE (US); Steven Matthew Christensen, Gretna, NE (US); David Michael Christensen, Gretna, NE (US)

(21) Appl. No.: 14/855,527

(22) Filed: Sep. 16, 2015

Related U.S. Application Data
(60) Provisional application No. 62/052,108, filed on Sep. 18, 2014.

(51) Int. Cl. B08B 3/04; B08B 3/10

(52) U.S. Cl. CPC B08B 3/047; B08B 3/10

(57) ABSTRACT

The separator/dryer includes a housing, removable collection trays, a separator assembly, a rinse assembly, and a heater/blower. The separator assembly separates the ammunition casings from the clean media and the rinse waste and includes a rotating separator basket disposed within the housing on a motor driven shaft. The rinse assembly provides a water shower to rinse any cleaning residue, carbon particulate and dust from the ammunition casings and the cleaning media. The heater/blower circulates a stream of hot air into the housing interior to dry ammunition casings and the cleaning media. The removable collection trays are vessels for collecting both the rinsed and dried ammunition casings and the rinsed and dried clean media.

This application claims priority from co-pending U.S. Provisional Patent Application Ser. No. 62/052,108 filed on Sep. 18, 2014, which is hereby incorporated by reference.

This invention relates apparatus used for reloading firearm ammunition, and specifically an apparatus for separating and drying ammunition casing and cleaning media.

### BACKGROUND OF THE INVENTION

Generally, small firearms ammunition casing can be reloaded, but first must be cleansed of the dirt and fouling created during discharge of the round. Generally, casings are cleaned in a three step process consisting of “tumbling” the casings in the granular cleaning medium, then separating the tumbled casings from the cleaning medium, washing the casings to remove any cleaning medium dust or residue, and finally drying the casings before reloading.

Mechanical devices, commonly referred to as tumblers, have been developed that stir, roll and vibrate the casings in a granular cleaning media, typically crushed walnuts or small bits of stainless steel rod (steel rod shot) to remove any carbon fouling or dirt from the casings. The granular cleaning medium acts as an abrasive that cleans and lightly polishes the casings. In addition, a variety of mesh screens, sieves and mechanical filtering devices have been developed to physically separate the “tumbled” casings from the granular cleansing medium. Heretofore, washing the separated tumbled casings has been accomplished by hand washing or washing in a conventional dish washer type device. Moreover, drying the separated tumbled casings has been accomplished by simply air drying or the manual use of hand blow dryers.

### SUMMARY OF INVENTION

The present invention provides an apparatus for rinsing, drying and separating ammunition casings from the granular cleaning media. The separator/dryer reduces the time and labor required for preparing ammunition casings for reload and recovering reusable cleaning media, such as stainless steel rod shot. The separator/dryer of this invention includes a housing, removable collection trays, a separator assembly, a rinse assembly, and a heater/blower. The housing provides the support structure and enclosure for the rinsing, drying and separating of the ammunition casings from the cleaning media and the rinse waste. The rinse assembly provides a water shower to rinse any cleaning residue, carbon particulate or dust from the ammunition casings and the cleaning media. The heater/blower circulates a stream of hot air into the housing interior to dry ammunition casings and the cleaning media. The separator assembly is used to initially separate the ammunition casings from the clean media and any rinse waste (water, soapy residue, and carbon fouling). The separator assembly includes a separator basket, which is a filtering vessel into which the tumble cleaned mixture of ammunition casings, granular cleaning media and cleaning fluids is initially deposited. The separator basket is suspended within the housing interior above collection trays for longitudinal rotation about a motor driven shaft. The collection trays collect both the dried ammunition casings and clean media. The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a front perspective view of an exemplary embodiment of the separator/dryer device of this invention;

FIG. 2 is another front perspective view of the separator/dryer of FIG. 1 showing the lid and front panel door open and the collection trays partially removed;

FIG. 3 is a rear perspective view of the separator/dryer of FIG. 1;

FIG. 4 is a side sectional view of the separator/dryer of FIG. 1 illustrating a first operational step showing the rear panel door inserted;

FIG. 5 is a side sectional view of the separator/dryer of FIG. 1 illustrating a second operational step showing the casings and media mix loaded into the separator basket;

FIG. 6 is a side sectional view of the separator/dryer of FIG. 1 illustrating a third operational step showing the casing and media mix being rinsed;

FIG. 7 is a side sectional view of the separator/dryer of FIG. 1 illustrating a fourth operational step showing the rear panel door removed and the casing and media mix drying;

FIG. 8 is a side sectional view of the separator/dryer of FIG. 1 illustrating a fifth operational step showing the first collection tray being removed;

FIG. 9 is a side sectional view of the separator/dryer of FIG. 1 illustrating a sixth operational step showing the second collection tray being inserted;

FIG. 10 is a side sectional view of the separator/dryer of FIG. 1 illustrating a seventh operational step showing the separator basket being opened;

FIG. 11 is a side sectional view of the separator/dryer of FIG. 1 illustrating an eighth operational step showing the casings deposited on the second collection tray;

FIG. 12 is a side sectional view of the separator/dryer of FIG. 1 illustrating a ninth operational step the first and second collection trays being removed;

FIG. 13 is a side sectional view of the separator/dryer of FIG. 1 illustrating a tenth operational step showing empty collections trays and the rear panel door being inserted;

FIG. 14 is a side sectional view of the separator/dryer of FIG. 1 illustrating a eleventh operational step showing the lid being opened; and

FIG. 15 is a side sectional view of the separator/dryer of FIG. 1 illustrating a twelfth operational step showing separator/dryer ready to reload.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The separator/dryer of this invention is used in preparation of previous discharged ammunition casings for reload. The separator/dryer rinses, dries and separates the casings from the granular cleaning media and is particularly useful for recovering the stainless steel rod shot used in some tumble cleaning processes, although it may be used to rinse, dry and separate casings from any cleaning media. In a typical tumble cleaning process with stainless steel rod shot, fouled ammunition casings are cleaned in a tumbler using stainless steel rod shot mixed with soapy water. Once the casings are cleaned in the tumbler, the tumbled mixture of casings, cleaning media and fouled soapy water is dumped into the separator/dryer, which rinses, dries and separates the casings from the cleaning media and the rinse waste (water, carbon fouling, dirt, soap and any other residue) for collection and reuse.

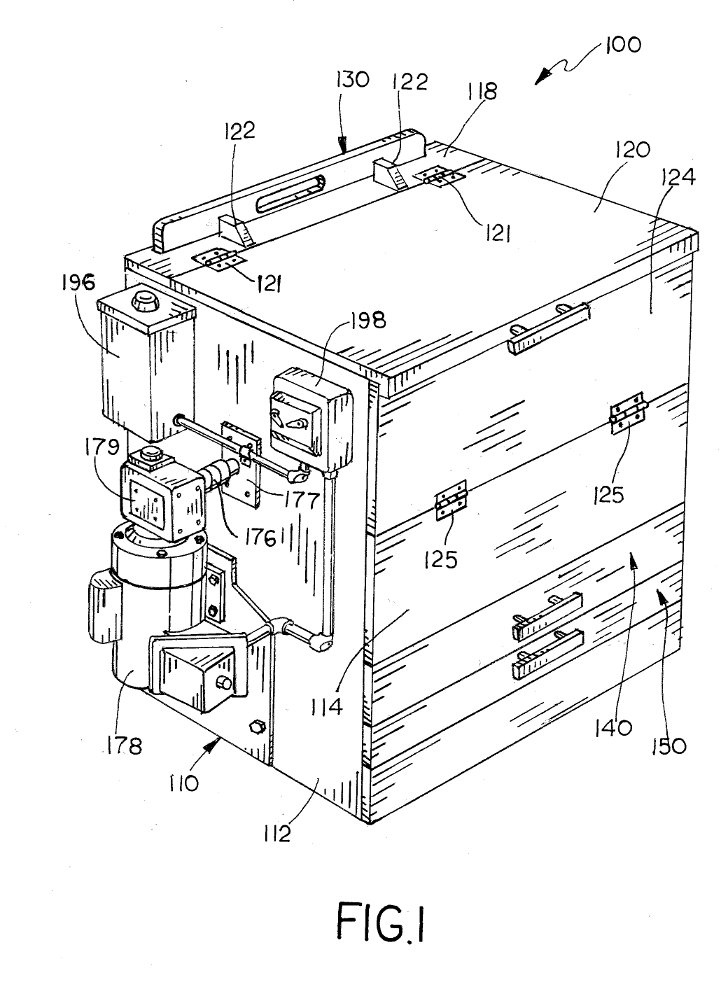

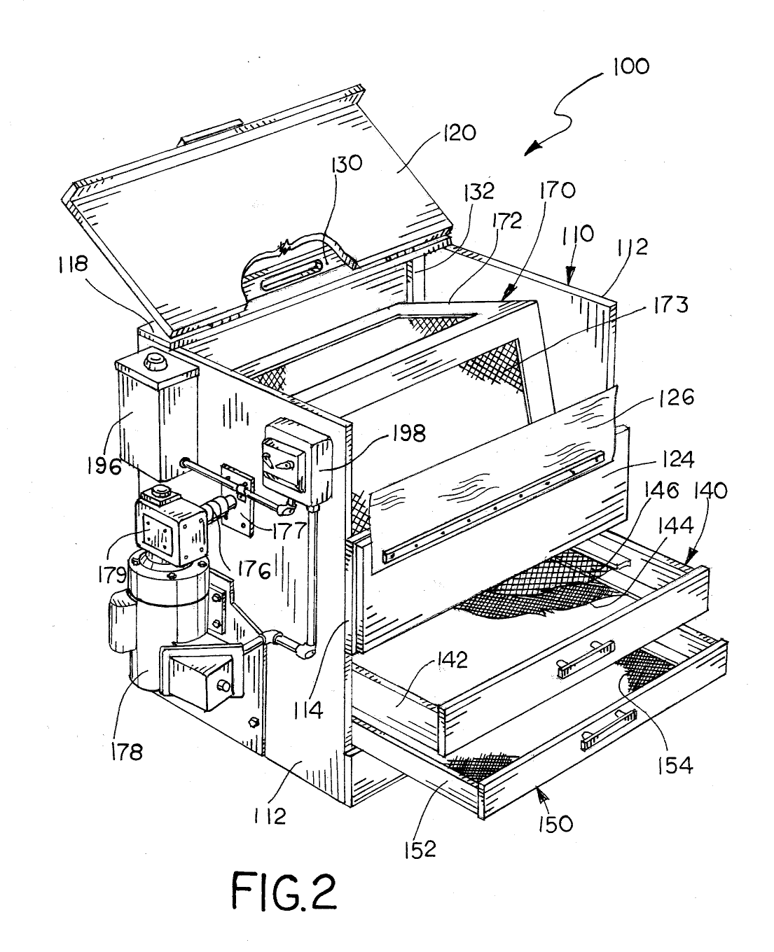

Referring now to the drawings, FIGS. 1-15 illustrate an exemplary embodiment of the separator/dryer of this invention, which is designated generally as reference numeral 100. As shown best in FIGS. 1-3, separator/dryer 100 includes: a housing 110, removable collection trays 140, 140′ and 150, a separator assembly 170, a rinse assembly 180, and a heater/blower 190. Housing 110 provides the support structure for the other components and assembles and the enclosure for the rinsing, drying and separating of the ammunition casings from the cleaning media 14 and the rinse waste 16. Rinse assembly 180 provides a water shower to rinse any cleaning residue, carbon particulate or dust from ammunition casings 12 and cleaning media 14. Heater/blower 190 circulates a stream of hot air into housing interior 111 to dry ammunition casings 12 and cleaning media 14. Separator assembly 170 is used to initially separate ammunition casings 12 from clean media 14 and rinse waste as it is rinsed and dried. Collection trays 140 and 140′ act as the primary vessels for collecting both the rinsed and dried ammunition casings 12 and the reusable clean media 14. Collection tray 150 acts as a final “catch-all” vessel for any loose or remaining casings 12 or cleaning media 14.

Generally, housing 110 is a watertight rectangular box constructed from rust and chemical resistant materials, such as stainless steel and polymer plastics, using conventional manufacturing techniques. Housing 110 has an interior 111 defined by a pair of opposed side panels 112, a front panel 114, a rear panel 116 and a top panel 118. Housing 110 includes a hinged lid 120 and a hinged front panel cover 124 that open and close to provide access into housing interior 111. Lid 120 is pivotally connected to top panel 118 by a pair of piano hinges 121. A pair of lid stops 122 are mounted to top panel 118 to support lid 120 in its open position. Front panel cover 124 is pivotally connected to front panel 114 by a pair of piano hinges 125. A pliable seal flange 126 is connected to front panel cover 124 to hermetically seal the seam between the panel cover and front panel 114 when the panel cover is in its closed position. Rear panel 116 has a large central opening 117. Housing 110 includes a stainless steel screen 131 seated within rear panel opening 117 and a removable rear cover 130 that covers rear panel opening 117. Rear cover 130 is inserted into housing 110 through a slot opening 119 in top panel 118 and is held over rear panel opening 117 by flanged tracks 132 affixed to rear panel 116. Housing 110 includes a drain pan 160 for collecting rinse waste. A drain port 162 is seated in rear panel 116 and connected to a drain line 164 that transports rinse waste 16 from separator/dryer 100 for disposal.

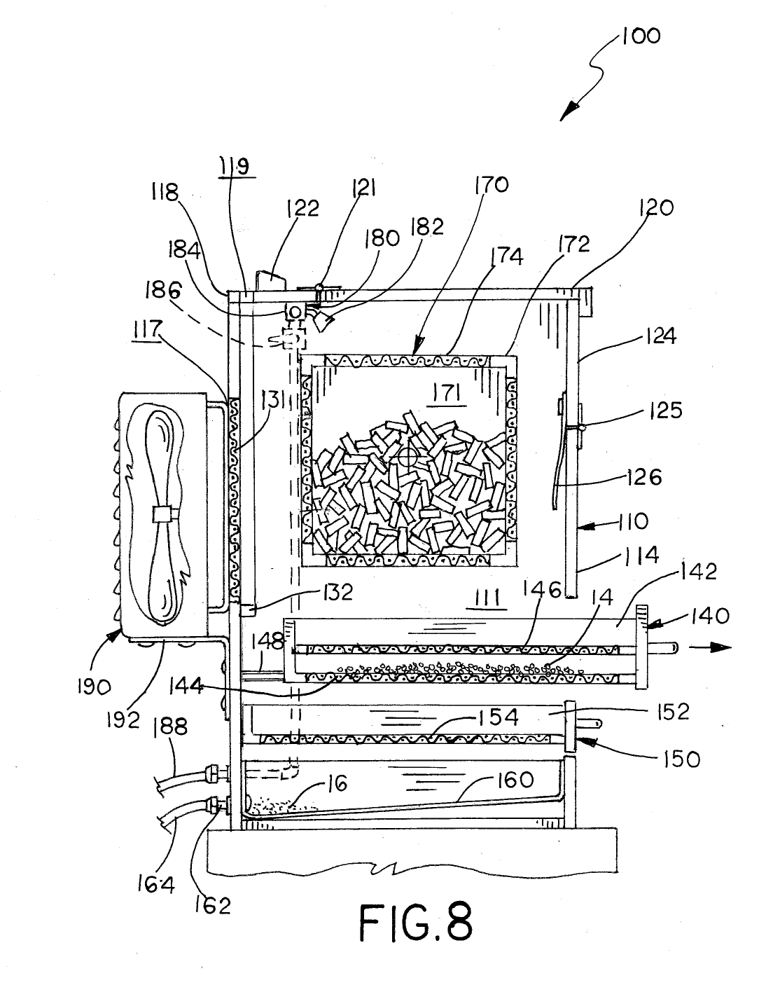

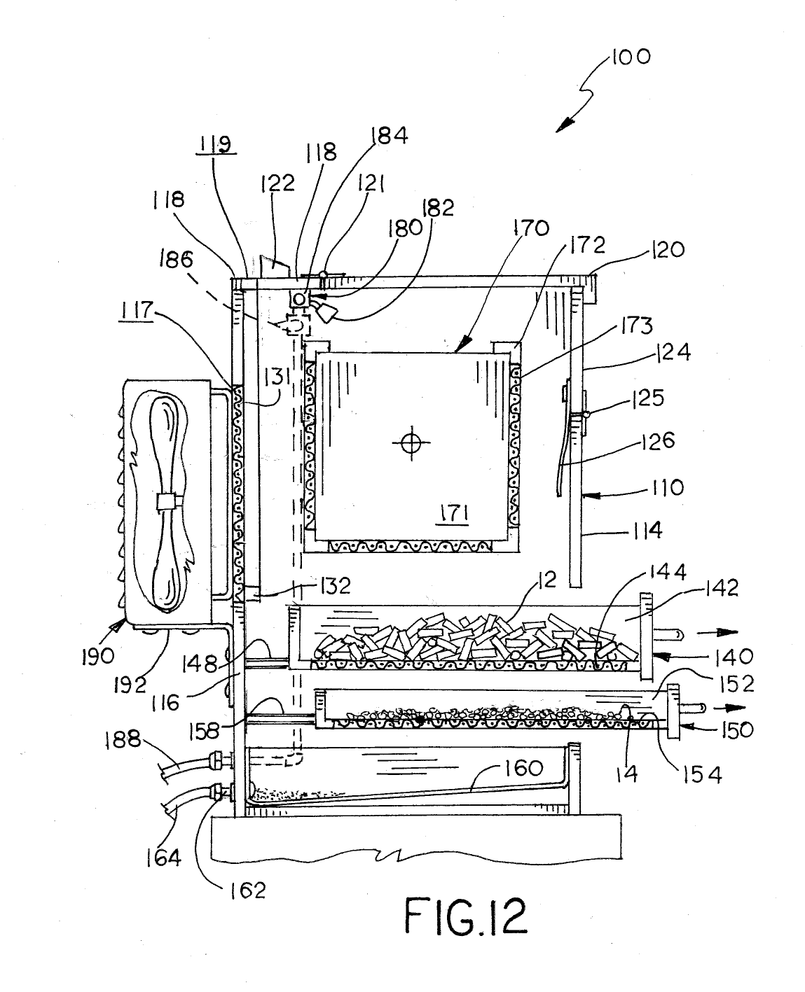

One of two removable collection trays—collection (casing) tray 140 or collection (media) tray 140′ is inserted into an upper opening (not numbered) in front panel 114. Collection trays 140 and 140′ are supported within housing interior 111 by a pair of support flanges 148 affixed to the inside of side panels 112 (FIG. 8). Collection tray 150 is inserted into a lower opening (not numbered) in front panel 114. Collection tray 150 sits atop a pair of support flanges 158 affixed to side panels 112 (FIG. 12). Collection tray 150 is suspended directly under either of collection tray 140 or 140′ and directly over drain pan 160 within the housing interior 111 near the bottom of housing 110.

Each collection tray 140 and 140′ includes a tray frame 142 and has a screened bottom 144. Screened bottom 144 is constructed of a stainless steel wire mesh having mesh openings sufficient to allow rinse waste 16 to pass through, while collecting the cleaning media 14. Collection (casing) tray 140 and collection (media) tray 140′ are substantially identical, except that collection (casing) tray 140 includes an additional screened bottom 146 suspended above screen bottom 144. Screened bottom 146 is constructed of a stainless steel wire mesh having mesh openings sufficient to allow the cleaning media 14 to pass through, while collecting ammunition casings 12. Like collections trays 140 and 140′, collection tray 150 includes a tray frame 152 and a screened bottom 154. Again, screened bottom 154 is constructed of a stainless steel wire mesh having mesh openings sufficient to allow rinse waste 16 to pass through, while collecting the cleaning media 14.

Separator assembly 170 includes a rotating separator basket 172, drive shaft 176, drive motor 178 and a gear box 179. Separator basket 172 is a filtering vessel into which the tumbled mixture of ammunition casings, cleaning media and fouled soapy water is initially deposited. Separator basket 172 is a rectangular box formed from a hollowed frame (not numbered) and having screened sidewalls 173 and a removable side panel 174. Screened sidewalls 173 are constructed from a stainless steel wire mesh having openings sufficient to allow cleaning media 14 to pass through, but retain ammunition casings 12. Removable side panel 174 is detachably mounted to basket 172 to provide access to the interior of the basket. As shown, side panel 174 is a removable panel connected to the body of separator basket 172 by any conventional methods, such as pins, cotter keys or fasteners as desired and appropriate. Alternatively, side panel 174 may be hinged to the body of separator basket 172 and locked in the closed position by similar pins, keys and fasteners. Separator basket 172 is suspended between side panels 112 within housing interior 111 above collection trays 140 and 150 for longitudinal rotation about a drive shaft 176. Shaft 176 extends through bearing blocks 177 mounted to side panels 112 and is operatively connected to motor 178 by a gearbox 179. Motor 178 drives shaft 176 to turn separator basket 172 inside housing interior 111. Motor 178 is activated by a switch on control box 198 connected to an electrical power distribution box 196.

Rinse assembly 180 includes a plurality of spray nozzles 182, a manifold 184, a supply line 188 and a shutoff valve 186. Supply line 188 is adapted to connect to any available water source, such as a conventional water tap. Typically, shutoff valve 186 is a conventional ball valve, which controls the flow of water into manifold 184. Shutoff valve 186 is mounted to the outside of the opposite side panel 112 from motor 178 and control box 198. Manifold 184 is mounted to top panel 118 inside housing interior 111. Spray nozzles 182 are fitted to manifold 184 to spray water into housing interior 111 and onto separator basket 172.

Generally, heater/blowers 190 are conventional electric space heaters, but in certain embodiments may be purpose built units designed particularly for the application of the present invention. Heater/blower 190 includes a motor driven fan (not numbered) and a heating element (not shown). The fan and heating elements are of conventional design and well known in the art. Heater/blower 190 is mounted to rear panel 116 on brackets 192 and positioned directly over rear planel opening 117. Heater/blower 190 is electrically wired to control box 198 and power distribution box 196. The motor driven fan and heating element of heater/blower 190 is activated by a switch on control box 198. When activated, heater/blower 190 blows heated air through screen 131 in rear panel opening 117 into the housing interior and directly into separator basket 172. The heated air flow from heater/blower 190 also circulates through collection trays 140 and 150.

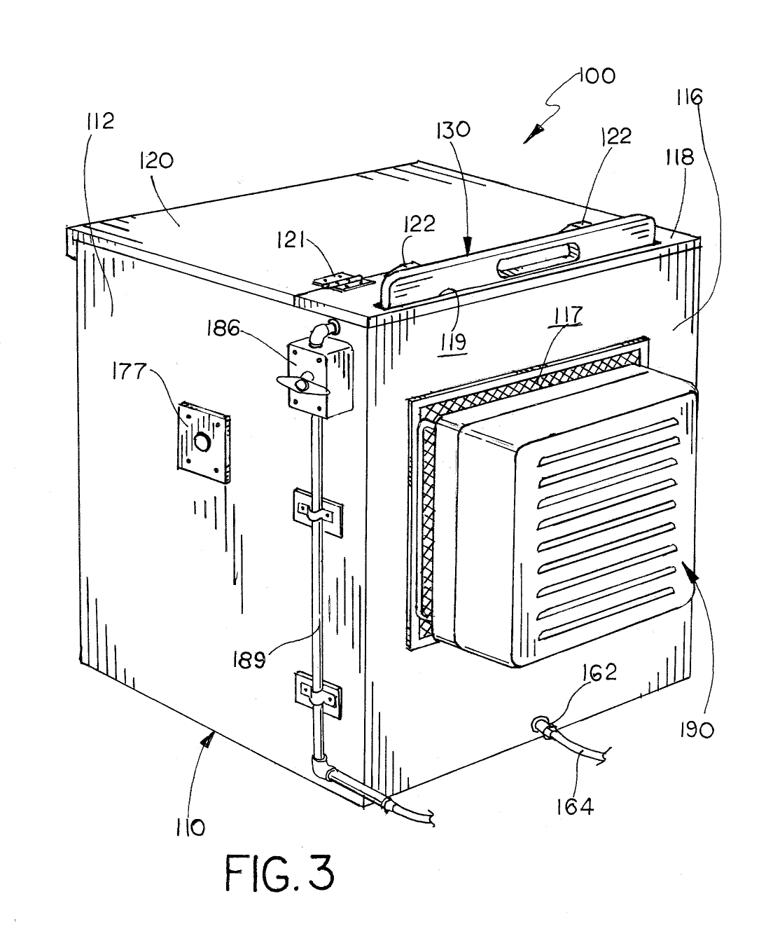

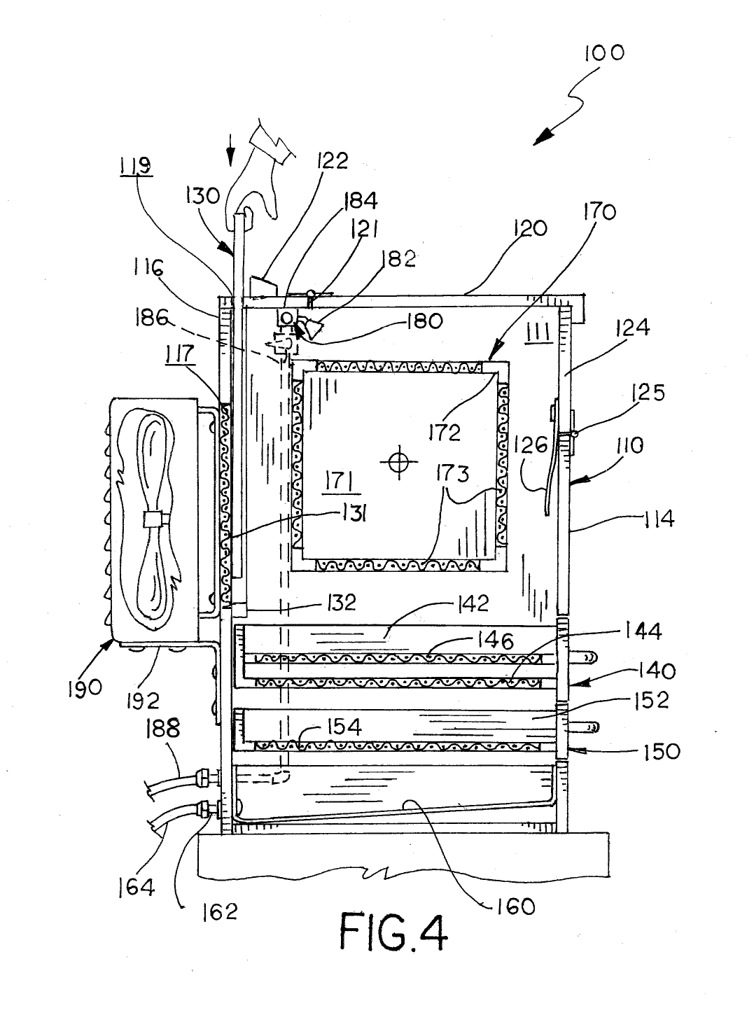

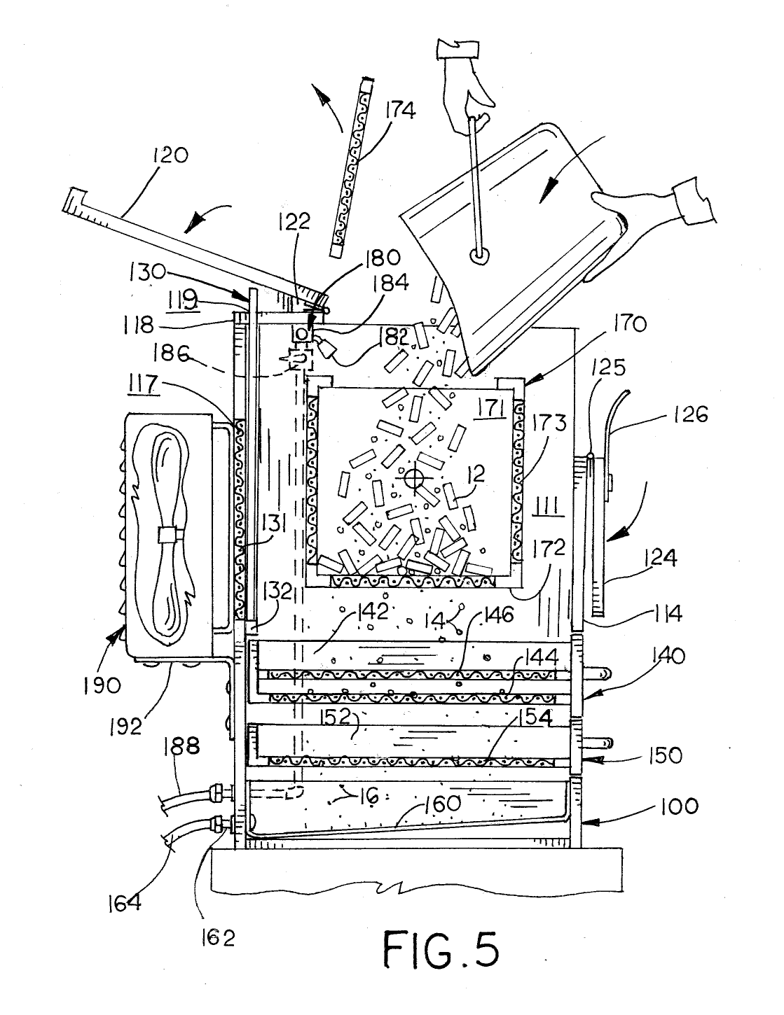

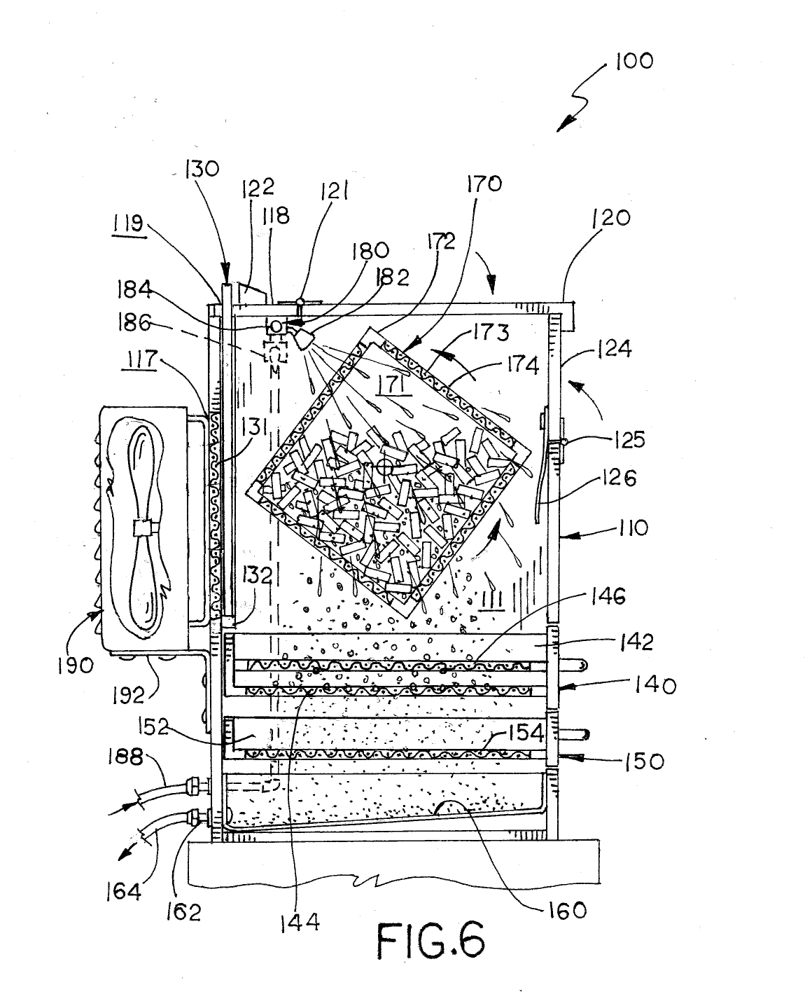

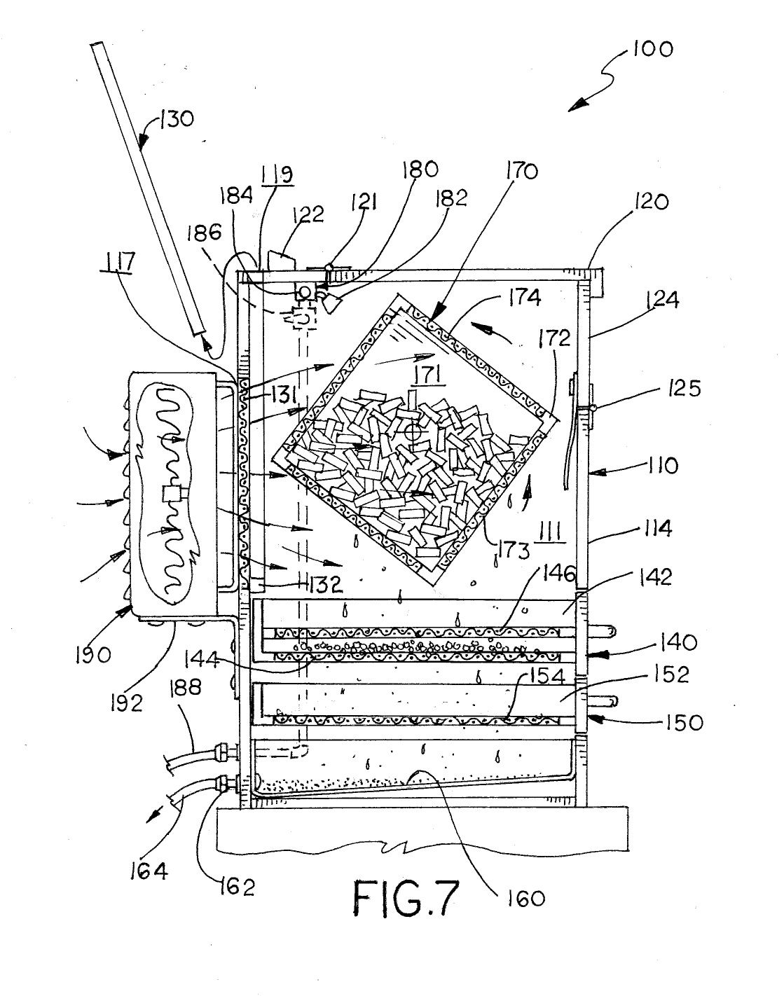

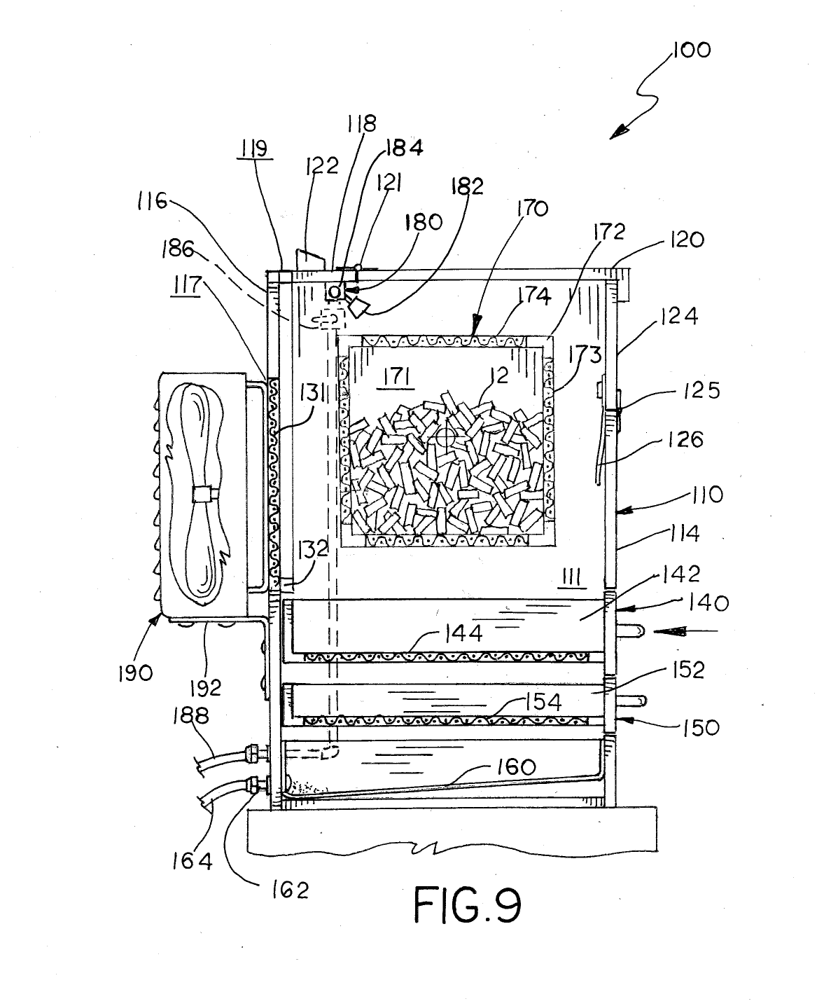

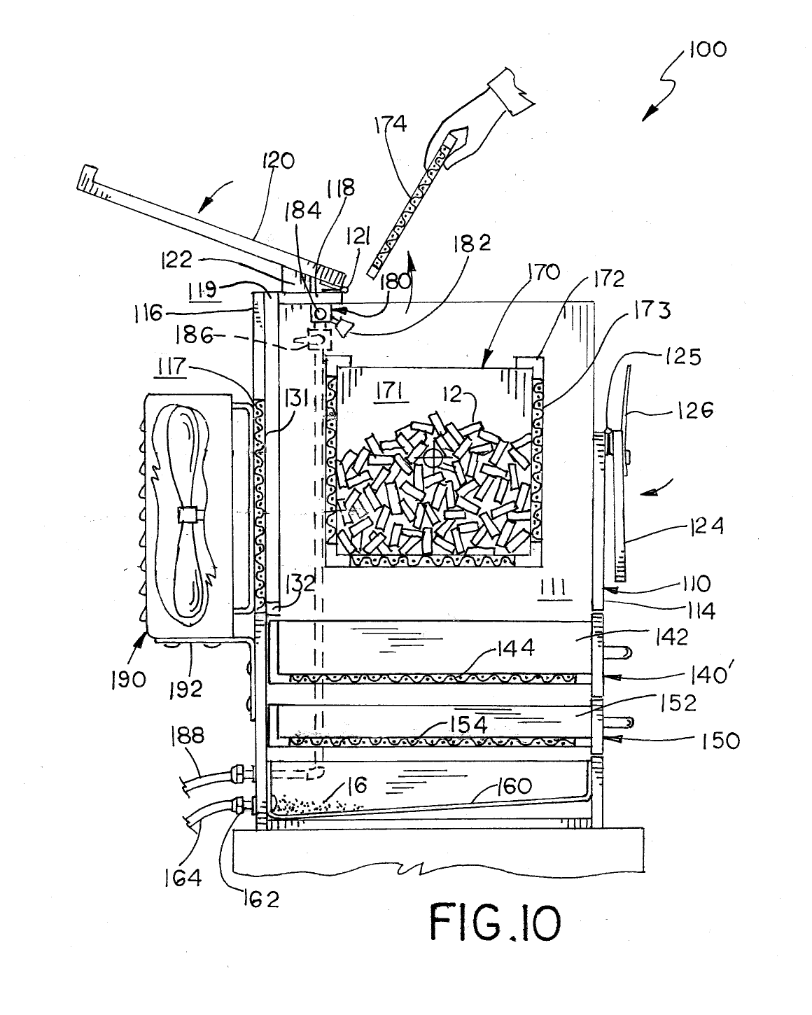

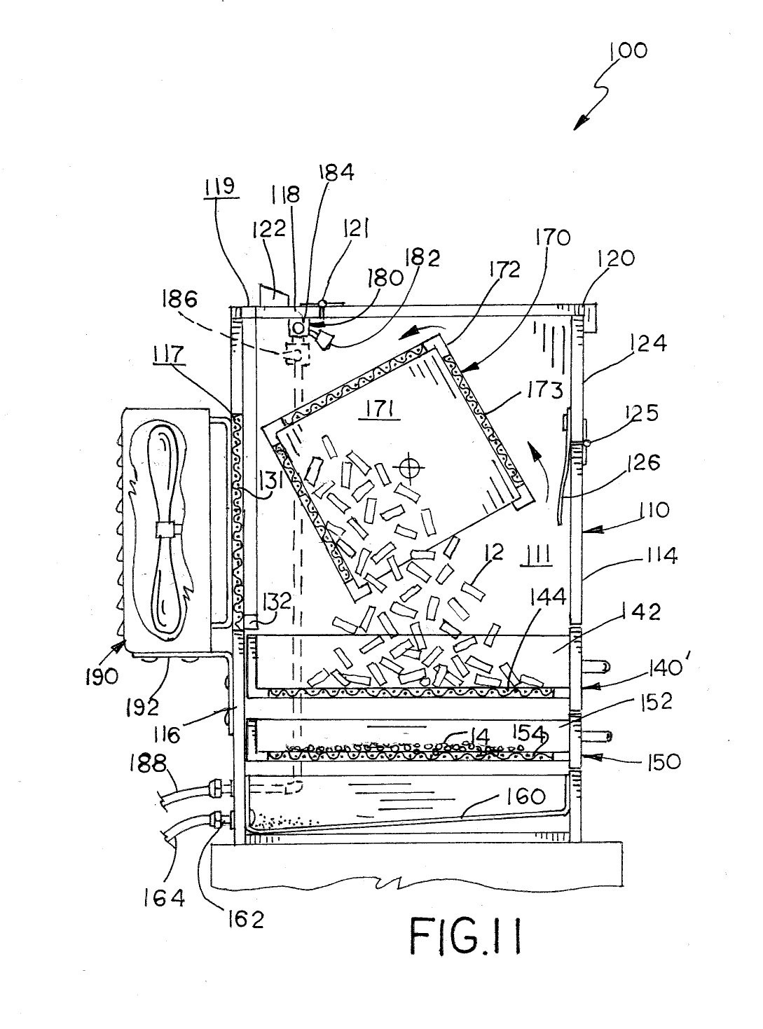

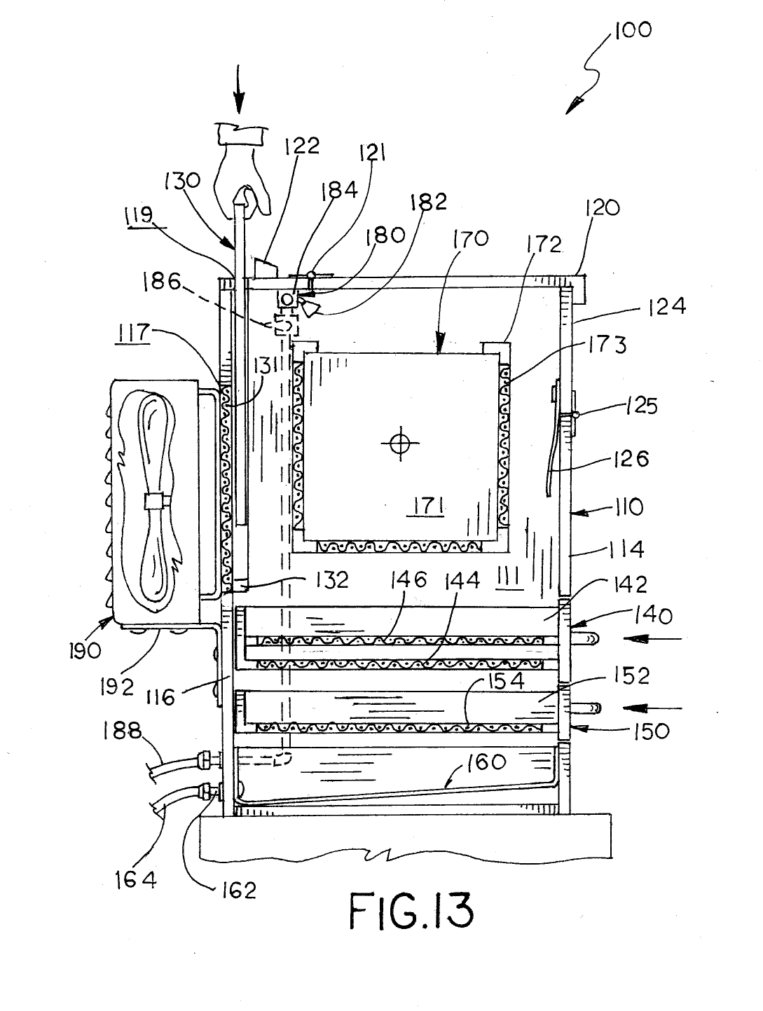

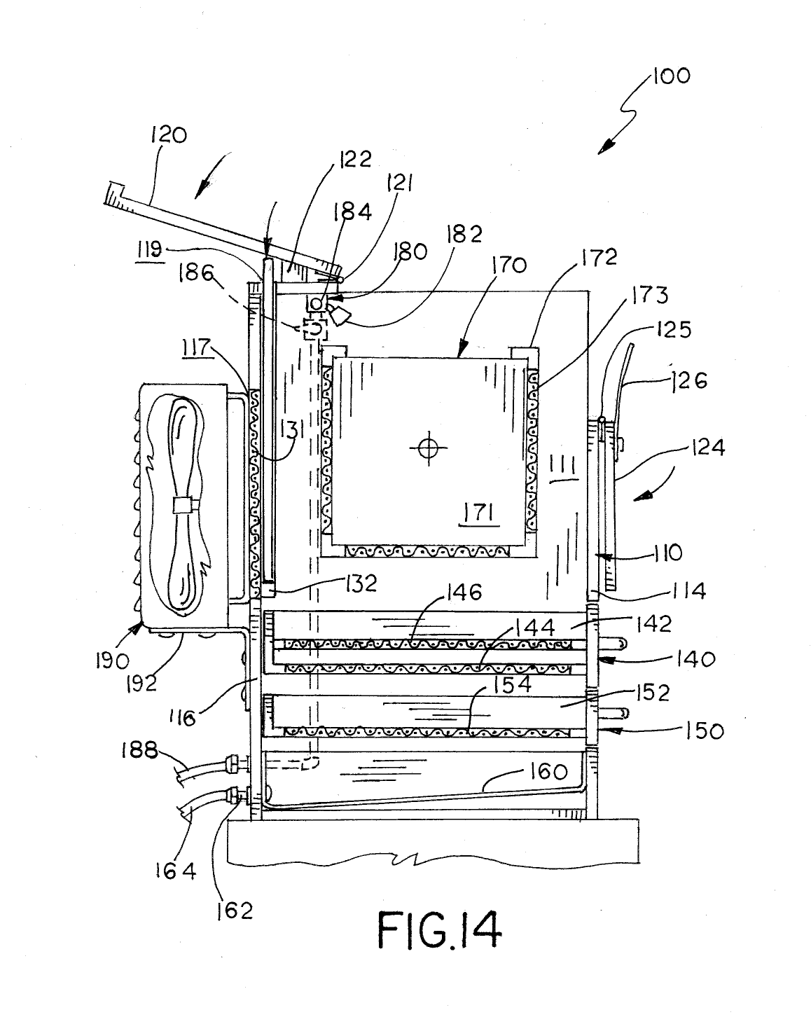

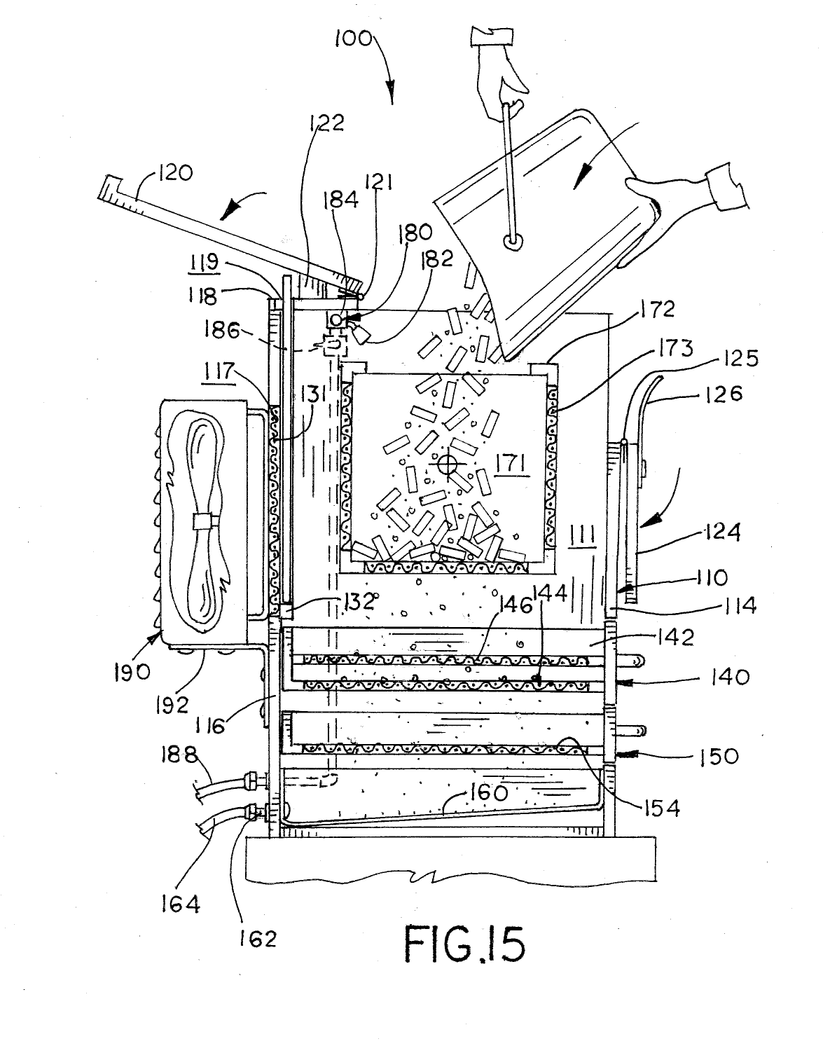

FIGS. 4-15 illustrate the operation of separator/dryer 100. First, rear panel cover 130 is inserted into slot 119 to cover rear panel opening 131 (FIG. 3). Next, lid 120 and front panel door 124 are opened to provide access to separator basket 170. Basket panel 174 is removed and basket 170 is filled with a batch of tumbled cleaned ammunition casings 12 and cleaning media 14 (FIG. 5). Typically, casings 12 and cleaning media 14 are suspended in a mixture of fouled soapy water, which is dumped into separator basket 170. Once lid 120 and front panel door 124 are closed, motor 178 is activated to rotate separator basket 170 and valve 186 is opened to spray water on the tumbled mixture (FIG. 6). Water from nozzle 182 rinses any soapy residue, carbon fouling and dirt from the casings and cleaning media. As separator basket 170 rotates, cleaning media and rinse waste (water, soap, carbon particulate and dirt) fall through screened walls 173 while casings 12 remain within the basket. As shown in FIG. 6, cleaning media falls into collection (media) tray 140 passing through screen bottom 142 and depositing atop screen bottom 144. Simultaneously, rinse waste fall through the screened bottoms 144, 146 and 154 of both collection trays onto drain tray 160. Once casings 12 have been throughly rinsed, valve 186 is closed to deactivate the rinse assembly, rear panel cover 130 is removed and heater/blowers 190 are activated (FIG. 7). Heater/blower 190 is activated by using switch 198. Heater/blower 190 blows hot air through separator basket 170, which continues to rotate tumble drying casings 12. The hot air also circulates through collection trays 140 and 150 to dry the cleaning media 14 deposited on screen bottom 144. As separator basket 170 continues to rotate, any remaining cleaning media is deposited into collection tray 140. Once casings 12 and cleaning media 14 are dry, heater/blower 190 is deactivated and collection tray 140 is removed (FIG. 8). The rinsed and dried cleaning media 14 deposited in collection (media) tray 140 is collected for reuse as needed. Now, collection (casing) tray 140′ is swapped for collection (media) tray 140 (FIG. 9). Once collection (casing) tray 140′ is inserted, Lid 120 and panel door 124 are opened and basket cover 174 is removed (FIG. 10). Next, separator basket 170 is rotated to dump the rinsed and dried casings 12 into collection (casing) tray 140′ (FIG. 11). Any remain cleaning media trapped in the casings 12 falls through screened bottom 144 and collects in collection tray 150. Collection trays 140 and 150 are removed and the rinsed and dried brass and remaining cleaning media is collected for reuse as needed. Next, rear panel cover 130, collection (media) tray 140 and collection tray 150 are reinserted into housing 110 (FIG. 13). Lid 120 and front panel door 124 are reopened and basket panel 174 is removed (FIG. 14). Finally, separator/dryer 100 is ready to be reloaded to begin the separation and drying process again (FIG. 15).

One skilled in the art will note that the separator/dryer of this invention provides significant advantages over conventional equipment and processes used to prepare ammunition casing for reload. The separator/dryer of this invention is particularly useful for preparing ammunition cleaning in tumblers with reusable stainless steel rod shot. The separator/dryer allows for the convenient recovery of the stainless steel rod shot, although it can be used to recover all types of cleaning media. The separator/dryer combines the functions of rinsing, drying and separating the casings from the cleaning media within a single device, which significantly reduces the time and labor required for preparing ammunition casings for reload and recovering reusable cleaning media, such as stainless steel rod shot. The separator/dryer can be scaled to accommodate varying batch sizes by increasing the size and scale of the housing, the separator basket, the number of spray nozzles and heater/blowers as needed.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An apparatus for rinsing, drying and separating ammunition casings from cleaning media and rinse waste, including water, dirt and carbon fouling, the apparatus comprising:
a housing including a pair of opposed side panel, a rear panel, a front panel, and an interior defined therein;
a separator assembly mounted to the housing, the separator assembly includes a rotatable separator basket having a basket interior thereof for receiving a mixture of casings, cleaning media and rinse waste therein, the separator basket includes screened basket walls through which cleaning media and rinse waste passes;
a removable collection tray seated within the housing interior beneath the separator basket, the collection tray having a bottom through which rinse waste passes and upon which casings and cleaning media collects;
a rinse assembly mounted to the housing and adapted to connect to a water supply for spraying water into the housing interior through separator basket and collection tray; and
a blower mounted to the housing for moving air into the housing interior through the separator basket and the collection tray.

2: The apparatus of claim 1 wherein the blower includes a heating element for heating the air blow through the housing interior.

3: The apparatus of claim 1 wherein the rear housing panel has an opening therein, the blower is mounted to the rear housing panel over the opening so that the blower moves air into the housing interior through the opening.

4: The apparatus of claim 3 wherein the housing includes a rear panel cover adapted to access the opening in the rear housing panel.

5: The apparatus of claim 3 wherein the housing includes an air permeable screen enclosing the opening in the rear housing panel.

6: The apparatus of claim 1 wherein the separator assembly includes a motor mounted to the housing and operatively connected to the separator basket to rotate the basket and the mixture therein.

7: The apparatus of claim 6 wherein the separator assembly also includes a control part for selectively activating the motor to rotate the separator basket.

8: The apparatus of claim 1 wherein the separator basket has a side opening for accessing the basket interior and includes a removable panel for enclosing the basket interior.

9: The apparatus of claim 1 wherein the rinse assembly includes a spray nozzle mounted within the housing interior for directing water onto the separator basket.

10: The apparatus of claim 9 wherein the rinse assembly also includes a valve part mounted to the housing and operatively connected to the nozzle to selectively control the flow of water to the nozzle.

11: The apparatus of claim 10 wherein the rinse assembly also includes a manifold mounted within the housing interior and a supply line mounted to the housing, the nozzle and valve part operatively connected to the manifold, the supply line connected to the valve part and a water supply.

12: The apparatus of claim 1 wherein the collection tray bottom includes a first screen panel through which rinse waste passes.

13: The apparatus of claim 12 wherein the collection tray bottom includes a second screen panel through which clean media and rinse waste passes.

14: The apparatus of claim 1 and a second removable collection tray seated within the housing interior beneath the first collection tray, the second collection tray having a bottom through which rinse waste passes and upon which the cleaning media collects.

15: The apparatus of claim 1 wherein the housing also includes a top panel having a top panel opening therein for providing access to the housing interior, and a lid pivotally connected to the top panel for enclosing the top panel opening.

16: The apparatus of claim 1 wherein the front panel includes a front panel opening therein for providing access to the housing interior, and a front panel cover pivotally connected to the front panel for enclosing the front panel opening.

17: The apparatus of claim 1 wherein the housing includes a drain pan seated within the housing interior under the collection tray, the drain pan for collecting rinse waste therein.

18: The apparatus of claim 17 wherein the housing also includes a drain port in flow communication with the drain pan through which rinse waste drains from the drain pan.
